(19) United States
(12) Patent Application Publication
(10) Pub. No.: US 2024/0175383 A1
(43) Pub. Date: May 30, 2024

(54) HEATING DEVICE FOR HEATING A GAS FLOW

(71) Applicant: Friedrich Boysen GmbH & Co. KG, Altensteig (DE)

(72) Inventors: Marvin Gamst, Albstadt (DE); Andres Haas, Loßburg-Wittendorf (DE); Heinz Kornherr, Weil der Stadt (DE)

(21) Appl. No.: 18/519,578

(22) Filed: Nov. 27, 2023

(30) Foreign Application Priority Data
Nov. 29, 2022 (DE) 102022131601.7

(51) Int. Cl. F01N 3/20; F01N 3/28

(52) U.S. Cl. CPC F01N 3/2013; F01N 3/2803; F01N 2240/16

(57) ABSTRACT

A heating device for heating a gas flow, in particular an exhaust gas flow of an internal combustion engine, comprises an electrically conductive heating element; and a carrier device having at least one electrically insulating carrier element for the electrically conductive heating element. The heating device is characterized in that the electrically conductive heating element is formed as a three-dimensional structure whose surface is at least sectionally formed from triply periodic minimal surfaces.

### CROSS-REFERENCE TO RELATED APPLICATIONS

This application claims the benefit of foreign priority under 35 U.S.C. § 119 of German patent application number 102022131601.7 filed on Nov. 29, 2022. The contents of this application are incorporated herein by reference in their entirety.

### INTRODUCTION

The invention relates to a heating device for heating a gas flow, in particular an exhaust gas flow of an internal combustion engine.

Catalytic converters, among other things, are used for exhaust gas after treatment in vehicles. Catalytic converters convert pollutants such as nitrogen oxides into harmless substances and thus serve to purify the exhaust gases produced by an internal combustion engine, for example a gasoline or diesel engine, by combustion of a fuel. The rate of conversion or transformation of pollutants into non-harmful substances is temperature dependent for the catalytic converters used. Pollutant emissions are only converted into non-harmful substances after a minimum temperature has been reached. To reduce pollutant emissions, it is therefore necessary to shorten the time period until reaching the minimum temperature. To this end, active heating measures, among other things, are used in particular with a view to future emission standards (EU7). Active heating measures, for example, include an electrically operated heating system (e-heating device). A heating effect of the electric heating systems is based on Joule's law (ohmic heating), i.e. the energization of a metallic heating matrix.

Known heating element structures are limited in their geometric design, i.e. in their volume, mass, surface and structure, due to manufacturing processes as well as thermomechanical and structural dynamic concerns.

It is an object of the invention to provide an apparatus with which an improvement in the thermodynamic and structural dynamic properties can be achieved compared to known apparatus from the prior art, and thus a faster attainment of the minimum temperature of, for example, a catalytic converter or a cleaning unit of a different design can be achieved.

This object is satisfied by a heating device having the features of claim 1.

### SUMMARY

The heating device according to the invention for heating a gas flow, in particular an exhaust gas flow of an internal combustion engine, comprises an electrically conductive heating element and a carrier device having at least one electrically insulating carrier element for the electrically conductive heating element. The heating device is characterized in that the electrically conductive heating element is formed as a three-dimensional structure whose surface is at least sectionally formed from triply periodic minimal surfaces.

The internal combustion engine can be configured as a combustion engine, for example as a petrol engine or a diesel engine. The internal combustion engine can also use employ other combustion processes, for example a Miller combustion process, or use other fuels, for example synthetic fuels or hydrogens. Pollutants are generated during operation of such a machine. The pollutant concentrations can be highly dependent on the operating conditions, for example on the type of fuel, the concentration of the fuel in the fuel-air mixture used, the amount of the fuel-air mixture, the rotational speed of the internal combustion engine, and/or the operating temperature of the internal combustion engine.

The exhaust gases produced by the combustion of a fuel in the internal combustion engine form a gas flow, in particular an exhaust gas flow. The exhaust gases are conducted to the outside through an exhaust gas treatment device via an exhaust gas system connected to the internal combustion engine, i.e. they are output to the environmental air of the vehicle. The exhaust gas treatment device can comprise a catalytic converter, wherein the gas flow is purified by a catalytic reaction in the catalytic converter when the gas flow flows through the catalytic converter. When the internal combustion engine is cold-started, the exhaust gases still have a comparatively low temperature. The catalytic converter, or a catalytic converter unit, through which the exhaust gas flows is likewise comparatively cool so that a threshold temperature or a minimum temperature at which an efficient purification of the exhaust gas can take place is often not yet reached. This has the result that the exhaust gases are not completely purified. Only with an increasing heating of the exhaust gases, and the associated heating of the catalytic converter, does the system enter a temperature range in which the desired catalytic reactions take place efficiently.

One measure for improving the cold-start behavior of a corresponding exhaust gas system can consist in providing a heating device, by means of which the onflowing exhaust gas is heated, in front of the catalytic converter or the exhaust gas treatment unit. The heating device can comprise a heating element that supplies additional heat to the exhaust gas flow in order to bring the system as quickly as possible into a temperature range in which an efficient exhaust gas aftertreatment can take place. However, other areas of use of the heating device are also possible.

For example, the heating device can be used to preheat combustion air in an intake tract of an internal combustion engine or, more generally, to heat any desired gas flow. The heating element can be formed from an electrically conductive material, in particular metal, so that the heating element is likewise electrically conductive. The heating device can additionally comprise a carrier device that carries the heating element. The carrier device can hold the heating element, for example, in the flow direction of the exhaust gas in front of the exhaust gas treatment unit. The at least one carrier element of the carrier device can be of a ring-like design or can have a basic geometry of a circular segment. For example, the at least one carrier element is a ring or a ring section that is applied to one of the end faces of the heating element if it has a circular contour. The carrier element is designed to be complementary to the basic geometry of the heating element. In contrast to the electrically conductive heating element, the at least one carrier element is formed from an electrically insulating material, for example from a temperature-resistant plastic and/or a ceramic material.

The surface of the three-dimensional structure of the heating element has characteristics that can be mathematically described as minimal surfaces. A minimal surface in this respect describes a surface in a three-dimensional space that has a minimal surface area locally to a defined boundary curve. Minimal surfaces are characterized in that they are substantially stress-free surfaces. For example, a minimal surface can be designed by a closed wire or wire ring by pulling the wire ring through soap suds. The resulting area of soap suds that is bordered by the wire ring has a minimal surface area and represents a minimal surface. If these minimal surfaces are repeated in all spatial directions, triply periodic minimal surfaces (TPMS) are created.

According to one embodiment, the electrically conductive heating element can have a substantially circular basic geometry. The basic geometry of the heating element can describe the geometry of a surface of the heating element that is impacted by a gas flow when entering the heating device. The heating element can have any suitable basic geometry. The basic geometry can be adapted to a geometry of an exhaust gas treatment unit arranged downstream, for example a catalytic converter. It can prove to be advantageous if the heating element and the catalytic converter have the same or substantially the same basic geometry. Substantially in this context can mean that minor deviations are possible. For example, a substantially circular basic geometry need not be exactly circular. Accordingly, a slightly oval-shaped basic geometry can still be described as a substantially circular basic geometry.

According to one embodiment, the three-dimensional structure of the electrically conductive heating element can have a uniform thickness. The heating element is formed as a three-dimensional structure that has a basic geometry. Starting from the two-dimensional basic geometry, the heating element extends in a third spatial direction. The thickness of the heating element can be described by the extent in the third spatial direction. The heating element has a uniform thickness if the extent of the heating element in the third spatial direction is constantly the same over the entire range of the basic geometry. A uniform thickness of the heating element can provide advantages with respect to the heating of the heating element in that all the regions of the heating element can be heated uniformly by energizing the heating element according to Joule's law.

According to another embodiment, the three-dimensional structure of the electrically conductive heating element can at least sectionally have a different thickness. The thickness of the heating element can vary over the range of the basic geometry of the heating element, i.e. the thickness of the heating element does not constantly have to be the same. The heating element can have a different thickness in some sections or regions than in other sections or regions. Individual sections or regions of the heating element can thereby be heated more strongly or more weakly. For example, regions at the center of the heating element can have a greater thickness than marginal regions of the heating element, whereby the regions at the center of the heating element would heat up less during an energization of the heating element than the marginal regions with a smaller thickness. In simplified terms, regions of the heating element with different thicknesses are a series connection of individual resistors. According to the law of an electrical series connection, the current strength in all the individual resistors is the same, whereas the total voltage is the sum of the individual voltages that decreases at the individual resistors. According to the formula P=I²*R, where P is the power, I is the current strength and R is the resistance, a region with a smaller cross-section results in a larger individual resistor at which a greater power thus decreases than in a region with a larger cross-section and thus a smaller resistor.

According to a further embodiment, the three-dimensional structure of the electrically conductive heating element can be formed from a temperature-resistant material. The material or a material from which the electrically conductive heating element or the surface of the electrically conductive heating element is formed can be a temperature-resistant or heat-resistant and/or corrosion-resistant material, in particular a metallic material, or a temperature-resistant or heat-resistant and/or corrosion-resistant alloy. When such a material or such an alloy is heated, a thick, stable oxide layer can form that protects the surface of the electrically conductive heating element. The strength can in this respect be maintained over a wide temperature range, whereby such materials are in particular suitable for high-temperature applications.

According to yet another embodiment, the three-dimensional structure of the electrically conductive heating element can have a plurality of gyroid cells and/or a plurality of Schwarz diamond cells. Both a gyroid cell and a Schwarz diamond cell form a minimal surface. A cell can represent a smallest unit of the minimal surface. By arranging the plurality of gyroid cells and/or Schwarz diamond cells in a row, i.e. repeating the minimal surface formed by the gyroid cell or by the Schwarz diamond cell, a three-dimensional structure whose surface is formed from minimal surfaces can be formed. Furthermore, the plurality of cells arranged in a row can have different wall thicknesses, in particular between 0.05 mm and 3 mm, different cell sizes and/or different cell types in space. The cell size in this respect describes a spatial extent in three dimensions of a cell. A cell can extend between 0.5 mm and 10 mm in each of the three spatial dimensions, in particular independently of one another. In addition to a cube-shaped design of the cell, for example by a uniform extent in all three spatial dimensions, a cell can also be cuboid-shaped. In addition to the previously described cell types of a gyroid cell and/or Schwarz diamond cell, the three-dimensional structure of the electrically conductive heating element can also, alternatively or additionally, have a plurality of Schwarz primitive (Schwarz P) cells, Schwarz hexagonal (Schwarz H) cells, Schwarz crossed layers of parallels (Schwarz CLP) cells, Fischer-Koch S cells, Fischer-Koch CY cells, Schoen I-WP cells, Neovius cells, or a combination thereof. All known minimal surfaces are generally suitable as a three-dimensional structure of the electrically conductive heating element.

According to a further embodiment, the electrically conductive heating element can be flowable through by the gas flow. The gas flow in this respect enters the three-dimensional structure of the heating element at one side, an inlet side of the heating element, penetrates the heating element in the flow direction of the gas flow and completely exits the heating element again at another side, an outlet side of the heating element. Within the heating element, the gas flow can be deflected in its flow direction. The deflection or a swirl of the gas flow can be caused by a design of the three-dimensional structure of the heating element.

According to yet another embodiment, the electrically conductive heating element can have at least two heating segments that are sectionally separated from one another by a gap that is in particular open at one side. The heating segments are formed from a three-dimensional structure whose surface is at least sectionally formed from triply periodic minimal surfaces. In this respect, the heating segments themselves can preferably be flowable through by the gas flow. The gas flow can flow through both the at least one gap and the heating segments themselves. In other words, the entire gas flow does not flow through the at least one gap during operation, but also flows through the heating segments. For this purpose, the heating segments can have channels whose walls enable an efficient transfer of heat from the conductive material of the heating element to the gas.

According to a further embodiment, the electrically conductive heating element can comprise at least two part bodies that are arranged such that the at least two part bodies can be flowed through successively or in parallel by the gas flow. The at least two part bodies can have an identical basic geometry, for example a substantially circular basic geometry. Each of the at least two part bodies has a three-dimensional structure whose surface is at least sectionally formed from triply periodic minimal surfaces. The at least two part bodies are formed from an electrically conductive material and are each electrically conductively connected to electrodes so that, on an energization, a potential difference can be formed between the electrodes by means of a control device to heat each of the at least two part bodies.

A successively supported arrangement of the at least two part bodies can be advantageous. In this respect, the at least two part bodies can be arranged in an axial direction that substantially corresponds to a flow direction of the gas flow so that the gas flow first flows through the first part body before the gas flow enters and flows through the second part body. An outer contour of the first part body and an outer contour of the second part body can be identical and can completely overlap. Due to such an arrangement of the at least two part bodies, the flow direction of the gas flow flowing through the at least two part bodies can be influenced in order, for example, to generate targeted swirls of the gas flow that can be advantageous for the heating of a catalytic converter arranged downstream.

The at least two part bodies can also be arranged in parallel. In such an arrangement, a portion of the gas flow can flow through a first part body and another portion of the gas flow can flow through a second part body. The part bodies arranged in parallel can be arranged in the same plane or can be arranged in parallel, in a spatially offset manner.

In such an embodiment, the at least two part bodies of the electrically conductive heating element can be electrically controllable separately from one another by means of a control device. The at least two part bodies can be electrically controllable such that each part body forms its own heating element. A different heating of the at least two part bodies can thereby be made possible.

In such an embodiment, the at least two part bodies of the electrically conductive heating element can be electrically connected by means of a series connection or a parallel connection. If the at least two electrically conductive part bodies are electrically connected in series, an electrical output of the first part body is directly electrically connected to an electrical input of the second part body. A single current path is formed that first leads through the first part body and then through the second part body. Due to such a series connection of at least two part bodies, an electrical resistance of the heating element and thus a heating power for the heating element can be set.

If the at least two part bodies are electrically connected in parallel, the respective electrical inputs of the at least two part bodies and the respective electrical outputs of the at least two part bodies are electrically connected to one another. At least two current paths are formed, wherein the first current path leads through the first part body and the second current path leads through the second part body. Consequently, the current path splits.

According to a further embodiment, the at least one carrier element can at least sectionally cover a marginal region of the electrically conductive heating element. The at least one carrier element can be connected in a form-fitting manner to the heating element. For example, the carrier device can comprise a first carrier element and a second carrier element that each surround at least a part of the periphery of the heating element and/or that each cover at least a part of a marginal region of at least one end face of the heating element. It is, for example, possible that the first carrier element and the second carrier element are each ring-shaped and each cover an outer marginal region of the two end faces. Carrier elements of the same design or of different designs or of the same or different dimensions can be combined to form a carrier device that is suitable for the respective application. Cost savings in terms of manufacture and assembly result when the first and the second carrier element are identical parts.

According to yet another embodiment, the at least one carrier element can have at least two openings through which the electrically conductive heating element can be electrically contacted. For the purpose of supplying the heating element with electrical energy, the at least one carrier element can have a first and a second opening through which the heating element can be electrically contacted. Corresponding connectors or electrodes are connected to a control device for operating the heating device. In embodiments with a plurality of carrier elements, each of the carrier elements can have (partial) openings. The (partial) openings can be configured to hold the connectors or electrodes.

According to a further embodiment, the electrically conductive heating element can be electrically connected to at least two electrodes, wherein an electrical potential difference can be formed between the at least two electrodes by means of a control device. By applying an external voltage to the at least two electrodes, an electrical potential difference builds up between the electrodes so that an electric current flows. The electrically conductive heating element in this respect represents an electrical resistance that leads to a heating of the heating element. The current flow between the electrodes, and thus the heating of the heating element, can be controlled by means of the control device. The greater this current flow, the greater the heating of the electrically conductive heating element or the faster a catalytic converter unit arranged downstream of the heating element can heat up.

In such an embodiment, the at least two electrodes can be arranged in an insulating manner against the at least one carrier element. The at least one carrier element is formed from an electrically insulating material, wherein the at least one carrier element is arranged in a housing. The housing can be formed from metal, for example. The at least two electrodes extend through both the housing and the at least one carrier element to energize the heating element or to provide it with electrical energy. The electrodes are furthermore connected to the control device by which a current flow and thus the energization of the heating element can be controlled. To allow the current flow from the control device to the electrodes and through the heating element, the at least two electrodes are arranged in an insulating manner against both the housing and the at least one carrier element.

The present invention further relates to an exhaust gas treatment device comprising an inlet and an outlet and at least one exhaust gas treatment unit for treating an exhaust gas flow, in particular a catalytic converter unit, wherein a heating device according to at least one of the embodiments described above is arranged between the inlet and the exhaust gas treatment unit, in particular directly in the flow direction of the exhaust gas in front of the exhaust gas treatment unit. The exhaust gas treatment device can have a single-piece housing component that receives the exhaust gas treatment unit and the heating device. Alternatively, the housing section of the heating device forms a part of a housing of the exhaust gas treatment device, in particular wherein an inlet of the exhaust gas treatment device is connected to a component of the housing section.

The present invention furthermore relates to an exhaust gas system of an internal combustion engine comprising an exhaust gas treatment device according to at least one of the embodiments described above.

The present invention furthermore relates to a vehicle comprising an internal combustion engine that is connected to an exhaust gas system described above.

### BRIEF DESCRIPTION OF THE DRAWINGS

The invention will be explained in the following purely by way of example with reference to advantageous embodiments and to the enclosed drawings.

FIG. 1 shows a perspective representation of an embodiment of the heating device.

FIG. 2A shows a schematic representation of an embodiment of the heating element.

FIG. 2B shows a schematic representation of a further embodiment of the heating element.

FIG. 3A shows a perspective representation of an embodiment of the heating element comprising triply periodic minimal surfaces.

FIG. 3B shows a perspective representation of a gyroid cell.

FIG. 3C shows a perspective representation of a further embodiment of the heating element comprising triply periodic minimal surfaces.

FIG. 3D shows a perspective representation of a Schwarz diamond cell.

FIG. 4A shows a schematic representation of an embodiment of an electrical control of the heating element.

FIG. 4B shows a schematic representation of an embodiment of an electrical control of the heating element comprising two part bodies, said electrical control being designed as a series connection.

FIG. 4C shows a schematic representation of a further embodiment of an electrical control of the heating element comprising two part bodies, said electrical control being designed as a parallel connection.

FIG. 5 shows a perspective representation of an exhaust gas treatment device.

### DETAILED DESCRIPTION

Heating elements in the automotive sector can consist of explicitly (constructively) produced geometries or of stochastic foam structures. A manufacturing process of such heating elements can in this respect be based on a joining and assembly technique of metal sheets, foams or on 3D printing.

The effectiveness of a heating element, for example a heating disk, can depend on how much energy can be transmitted in the form of heat to a substrate arranged downstream, for example a catalytic converter substrate. The surface of the heating element and the flow situation within a structure of the heating element can be decisive for the heat transfer from the heating element to the substrate.

Driving profiles and thus operating times and/or operating requirements for a heating element can be highly dynamic. A low thermal mass, large heat-transferring surfaces, and a generation of highly turbulent flow patterns should be reproduced in the best possible manner by a heating element to meet a dynamic requirement profile. However, due to geometry limitations, known heating elements cannot reproduce all the desired properties.

The heating device according to the invention represents an optimization and a further development of known electric heating systems. The heating device described herein in particular leads to an optimization of a heating element or a heating disk or a heating matrix, i.e. a core part of an electric heating system. This optimization can be achieved by means of a mathematically implicit geometry formulation of a surface of the heating element.

With implicitly produced structures, a reduction in the thermal mass of the heating element can be achieved while simultaneously increasing a heat-transferring surface and/or an increase in turbulent flows in the heat-transferring region of the heating element can be improved.

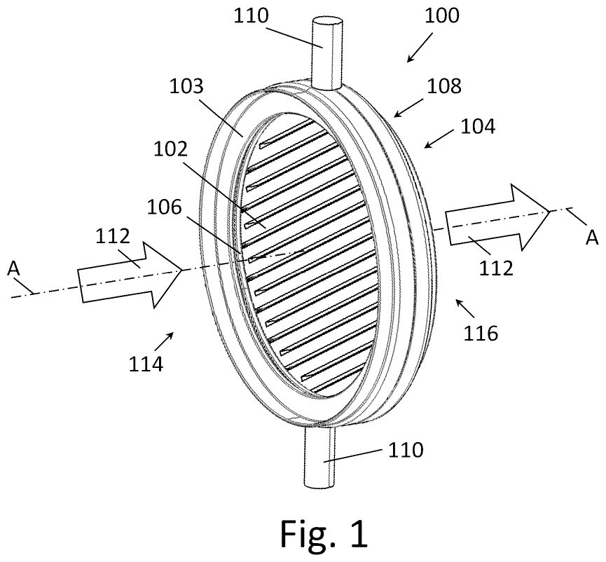

FIG. 1 shows a perspective representation of an embodiment of the heating device 100 according to the invention. The heating device 100 comprises an electrically conductive heating element 102 and a carrier device 104.

In this embodiment, the electrically conductive heating element 102 is configured as a heating disk, wherein the heating disk has a circular basic geometry with respect to a flow axis A. In general, both the basic geometry, or an outer contour, of the heating element 102 and an axial thickness of the heating element 102 are freely selectable and can be adapted to the respective requirements at hand.

The carrier device 104 carries or holds the electrically conductive heating element 102. According to this embodiment of the heating element 102, the carrier device 104 is also circular in shape. The carrier device 104 is generally adapted to the geometry of the outer contour of the heating element 102 and comprises at least one carrier element 106. The carrier element 106 is arranged in an electrically insulating manner between a housing part 103 and the heating element 102 at an end face of the heating element 102. The embodiment of the heating device 100 in FIG. 1 has two separate carrier elements 106, 108 that are formed from circular segments, that are adapted to the geometry of the outer contour of the heating disk, and that are each arranged at an end face of the heating element 102 in an electrically insulating manner between the heating element 102 and the housing part 103. The carrier elements 106, 108 are substantially covered by the housing part 103. Furthermore, the carrier elements 106, 108 almost completely surround the heating element 102 in the peripheral direction. Gaps are only provided in the region of the connectors that are configured as electrodes 110. In deviation from the embodiment shown, the at least one carrier element 106, 108 can at least sectionally cover a marginal region of the electrically conductive heating element 102.

Due to an almost complete enclosure of the heating element 102 by the carrier elements 106, 108, with gaps only being provided in the region of the electrodes 110, the electrically conductive heating element 102 is also insulated in the radial direction with respect to the flow axis A. To achieve a good electrical insulation, the carrier elements 108 are formed from an electrically insulating material, for example, from corundum, a glass ceramic material, mica, and/or another ceramic material.

In the region of the electrodes 110, at least one of the carrier elements 106, 108 or both carrier elements 106, 108 have openings through which the electrically conductive heating element 102 can be electrically contacted by means of the electrodes 110. The electrodes 110 can be guided through the openings and are arranged in an electrically insulating manner against the carrier elements 106, 108. Furthermore, the electrodes 110 are electrically conductively connected to the heating element 102. The heating element 102 can be electrically controlled and energized by means of a control device (not shown) via the electrodes 110. By applying a potential difference between the two electrodes 110, a current flow is formed between the two electrodes 110, whereby the heating element 102 heats up due to its electrical resistance (resistance heating). An energization of the heating element 102 with a surface formed from triply periodic minimal surfaces is generally possible.

The heating element 102 is formed as a three-dimensional structure such that the heating element 102 or the three-dimensional structure of the heating element 102 can be flowed through by a gas flow 112, in particular an exhaust gas flow of an internal combustion engine. The gas flow 112 enters the heating element 102 at an inlet side 114, flows through the three-dimensional structure of the heating element 102 substantially in a flow direction parallel to the flow axis A, and exits the heating element 102 again at an outlet side 116. The gas flow 112 is schematically indicated by two arrows in FIG. 1.

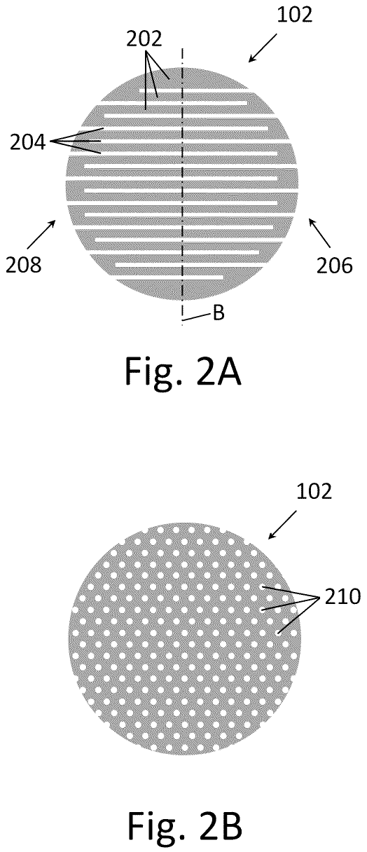

FIG. 2A shows a schematic representation of an embodiment of the heating element 102, wherein the heating element 102 has a circular basic geometry. The heating element 102 is at least partly, in particular completely, formed from an electrically conductive material and/or is at least partly coated with such a material. The heating element 102 has gaps 204 that extend in parallel and that sectionally separate individual heating segments 202 from one another. The gaps are alternately open at one side. In FIG. 2A, the side openings of the gaps 204 are alternately shown at a right margin 206 and at a left margin 208 with respect to an axis of symmetry B of the heating element 102. Figuratively speaking, a meandering or serpentine structure of the heating element 102 is hereby produced. The heating segments 202 do not represent an impenetrable flow resistance, but rather have a plurality of fine axial channels (not shown) through which the gas flow 112 can flow (see FIG. 1). The gas flow 112 can furthermore flow through the gaps 204 of the heating element 102. Due to a suitable contacting by means of at least two electrodes (see FIG. 1), a current flow through the meandering structure of the heating element 102 can take place and the heating element 102 can heat up.

FIG. 2B shows a schematic representation of a further embodiment of the heating element 102. As an alternative to the embodiment of a heating element 102 having a meandering structure shown in FIG. 2A, the heating element 102 can also have a three-dimensional structure that at least sectionally has a plurality of fine channels 210 through which the gas flow 112 can flow. In FIG. 2B, the channels 210 are schematically shown greatly enlarged. The basic geometry of the heating element 102 or the heating matrix in this embodiment is likewise circular (as in the embodiment of FIG. 2A). However, the shape of the basic geometry of the heating element 102 can be of any desired design. The alternative embodiment of the heating element 102 shown in FIG. 2B can be heated by a suitable contacting, for example by two or more mutually spaced-apart large-area electrodes on an outer surface of the heating element 102, and energizing.

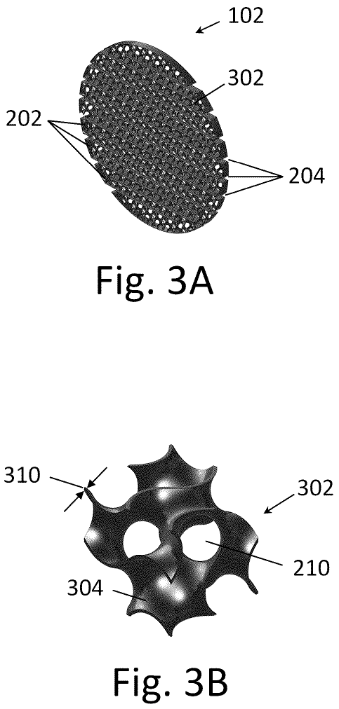

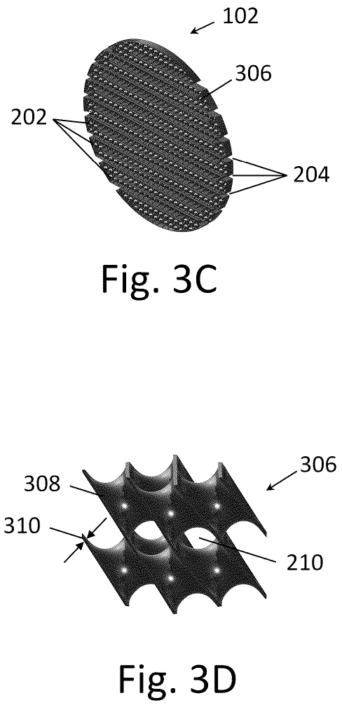

The basic geometry, and in particular a surface of the basic geometry of the heating element 102, can be described by any triply periodic minimal surfaces (TPMS). For example, the three-dimensional structure of the electrically conductive heating element 102 can have a plurality of gyroid cells and/or a plurality of Schwarz diamond cells, as described below with reference to FIGS. 3A to 3D. The three-dimensional structure of the heating element 102, formed from triply periodic minimal surfaces, can have advantages over known structures of heating elements 102. For example, the electrically conductive heating element 102 according to the invention can have advantageous properties in terms of deformation and energy absorption. Furthermore, the density, surface, and stiffness of the three-dimensional structure of the heating element 102 can be suitably determined according to the application. A very good resistance to fatigue and an efficient use of material, and thus cost potentials and/or a high permeability, for example of a gas flow 112, compared to known surface structures of heating elements 102 can likewise be possible by designing the surface of the three-dimensional structure of the heating element 102 from triply periodic minimal surfaces.

FIGS. 3A and 3C show perspective representations of embodiments of the heating element 102 with triply periodic minimal surfaces. Triply periodic minimal surfaces are surface structures known from nature (for example, soap skins). Minimal surfaces have a mean curvature of 0 at every point. Furthermore, minimal surfaces can be formulated implicitly. Various formulations exist for TPMS structures. The TPMS structures described below represent only a portion of suitable TPMS structures and are to be understood as examples.

The TPMS structure of the electrically conductive heating element 102 is formed from an electrically conductive and thermally resistant material, for example from a temperature-resistant material, in particular a metallic material. The surface, or at least sections thereof, of the heating element 102 can be formed from any suitable triply periodic minimal surface or any suitable combination of triply periodic minimal surfaces. A gyroid cell 302 (see FIG. 3B) represents a suitable TPMS structure, for example.

The three-dimensional structure of the heating element 102 from FIG. 3A is formed from a plurality of gyroid cells 302. A perspective representation of a single gyroid cell 302 is shown in FIG. 3B. The gyroid cell 302 has a three-dimensional structure 304 having a wall thickness 310 that separates a space into two oppositely congruent labyrinths of channels 210. The heating element 102 has a meandering structure (see FIG. 2A), but can also have any other suitable structure, for example a circular structure without gaps 204 as shown in FIG. 2B. The surface of the three-dimensional structure 304 of the heating element 102 has a plurality of triply periodic minimal surfaces. The three-dimensional structure 304 formed from a plurality of gyroid cells 302 can, at least sectionally, have a uniform thickness or a varying thickness.

In general, TPMS structures can be described from an addition of angular functions. For example, the gyroid cell 302 can be approximated by the following implicit equation:

cos(x)sin(y)+cos(y)sin(z)+cos(z)sin(x)=0.

The gyroid cell 302 is particularly advantageous since it is relatively easy to produce by means of 3D printing. The design of the channels 210 of the gyroid cell 302 can furthermore affect the flow direction of a gas flow 112 flowing through the cell and may, for example, result in turbulence of the gas flow 112, which can have a positive effect on the heat transfer from the heating element 102 to the gas flow 112 and/or from the gas flow 112 to an exhaust gas treatment unit arranged downstream of the heating element 102.

FIG. 3C shows a perspective representation of a further embodiment of the heating element 102 comprising triply periodic minimal surfaces. In this embodiment, the triply periodic minimal surfaces are formed by a plurality of Schwarz diamond cells 306. A perspective representation of a Schwarz diamond cell 306 is shown in FIG. 3D. The Schwarz diamond cell 306 has a three-dimensional structure 308 having a wall thickness 310 that comprises two intertwined congruent labyrinths of channels 210, each of which has the shape of an inflated tubular version of a diamond structure. The heating element 102 comprises heating segments 202 and gaps 204 that form a meandering basic geometry of the heating element 102. Other suitable basic geometries are also possible for the heating element 102 whose three-dimensional structure 308 is formed from Schwarz diamond cells 306. The three-dimensional structure 308 formed from a plurality of Schwarz diamond cells 306 can, at least sectionally, have a uniform thickness or a varying thickness.

For example, the Schwarz diamond cell 306 can be described by the following angular function:

sin(x)sin(y)sin(z)+sin(x)cos(y)cos(z)+cos(x)sin(y)cos(z)+cos(x)cos(y)sin(z)=0.

Schwarz diamond cells 306 are characterized by a relatively large surface compared to other minimal surfaces for the same volume. This can promote the heating of a gas flow 112 that flows through a heating element 102 whose structure is formed from Schwarz diamond cells 306.

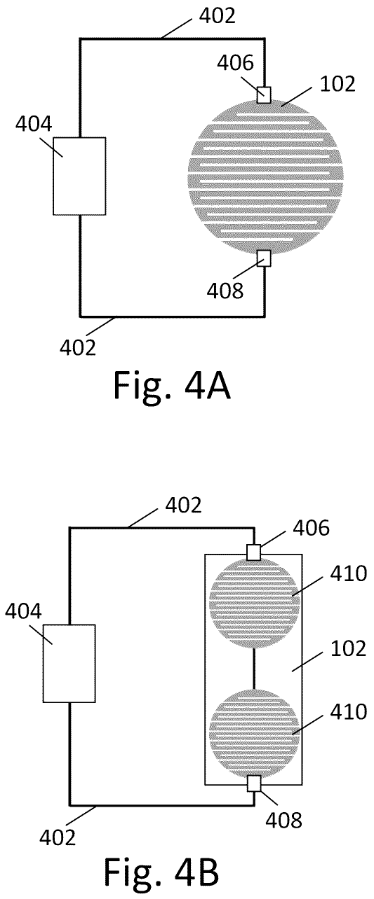

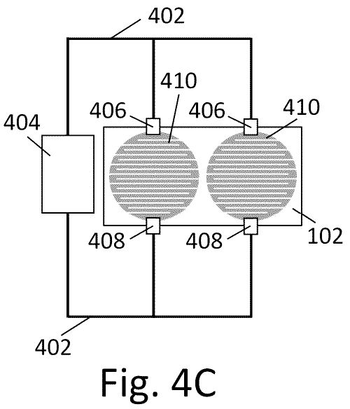

FIG. 4A shows a schematic representation of an embodiment of an electrical control of the heating element 102. The electrically conductive heating element 102 is electrically connected to a first electrode 406 and a second electrode 408. Both the first electrode 406 and the second electrode 408 are electrically connected to a control device 404 via an electrical line 402. By means of the control device 404, an electrical voltage can be applied to the first electrode 406 and to the second electrode 408 such that a potential difference (voltage difference) is formed between the first electrode 406 and the second electrode 408. For example, a positive voltage potential is applied to the first electrode 406 and a negative voltage potential is applied to the second electrode 408, or vice versa. The electrically conductive heating element 102 arranged between the first electrode 406 and the second electrode 408 has an electrical resistance. By applying two different voltage potentials to the first electrode 406 and the second electrode 408, a current flow is created between the first electrode 406 and the second electrode 408 and the heating element 102 hereby heats up due to the electrical resistance of the heating element 102 according to Joule's law (ohmic heating).

FIG. 4B shows a schematic representation of an embodiment of an electrical control of the heating element 102 comprising two part bodies 410, wherein the electrical control is designed as a series connection. According to the embodiment shown in FIG. 4A, the electrically conductive heating element 102 is electrically connected to a first electrode 406 and a second electrode 408. Both the first electrode 406 and the second electrode 408 are electrically connected to a control device 404 via an electrical line 402. By means of the control device 404, an electrical voltage can be applied to the first electrode 406 and to the second electrode 408 such that a potential difference (voltage difference) is formed between the first electrode 406 and the second electrode 408. For example, a positive voltage potential is applied to the first electrode 406 and a negative voltage potential is applied to the second electrode 408, or vice versa. The electrically conductive heating element 102 arranged between the first electrode 406 and the second electrode 408 comprises two electrically conductive part bodies 410 that are electrically conductively connected to one another.

The two part bodies 410 can—seen spatially—be arranged spaced apart from one another in the direction of the flow axis A (see FIG. 1), i.e. one after another, or spaced apart from one another in the direction of the axis of symmetry B, i.e. above or below one another, so that the two part bodies 410 can be flowed through by a gas flow 112. The two part bodies 410 are electrically connected in series (series connection) so that the electrical resistance of the respective part bodies 410 adds up to a total resistance of the heating element 102. By applying two different voltage potentials to the first electrode 406 and the second electrode 408, a current flow is created between the first electrode 406 and the second electrode 408, each part body 410 hereby heats up due to the electrical resistances of the part bodies 410 and the heating element 102 thereby also heats up according to Joule's law (ohmic heating). It is also possible to electrically control the—at least—two part bodies 410 of the heating element 102 separately from one another by means of a control device 404.

FIG. 4C shows a schematic representation of a further embodiment of an electrical control of the heating element 102 comprising two part bodies 410, wherein the electrical control is designed as a parallel connection. According to the embodiment in FIG. 4B, the heating element 102 is formed from two electrically conductive part bodies 410. The part bodies 410 can—seen spatially—be arranged spaced apart from one another in the direction of the flow axis A (see FIG. 1), i.e. one after another, or spaced apart from one another in the direction of the axis of symmetry B, i.e. above or below one another, so that the two part bodies 410 can be flowed through by a gas flow 112. The two part bodies 410 are electrically connected in parallel (parallel connection).

Each of the two part bodies 410 is electrically connected to a first electrode 406 and a second electrode 408. Thus, the heating element 102 comprises four electrodes 406, 408, two first electrodes 406 and two second electrodes 408 each for each part body 410. Both the respective first electrode 406 and the respective second electrode 408 are electrically connected to a control device 404 via an electrical line 402. By means of the control device 404, an electrical voltage can be applied to the respective first electrode 406 and to the respective second electrode 408 such that a potential difference (voltage difference) is formed between the respective first electrode 406 of a part body 410 and the respective second electrode 408 of a part body 410, resulting in a current flow between the respective first electrode 406 and the respective second electrode 408. For example, a positive voltage potential is applied to the respective first electrode 406 and a negative voltage potential is applied to the respective second electrode 408, or vice versa. By applying two different voltage potentials to the respective first electrode 406 and the respective second electrode 408, a current flow is created between the respective first electrode 406 and the respective second electrode 408, each part body 410 hereby heats up due to the electrical resistances of the part bodies 410 and the heating element 102 thereby also heats up according to Joule's law (ohmic heating). It is also possible to electrically control the—at least—two part bodies 410 of the heating element 102 separately from one another by means of a control device 404.

The surface of an electrically conductive heating element 102 formed, at least sectionally, from triply periodic minimal surfaces can be even further optimized according to the criteria of surface, resistance, counterpressure, and strength. In this respect, a potential of the heating device 100 according to the invention can be determined by means of measurement technology for temperature—thermography and thermocouples—and measurement technology for pressure.

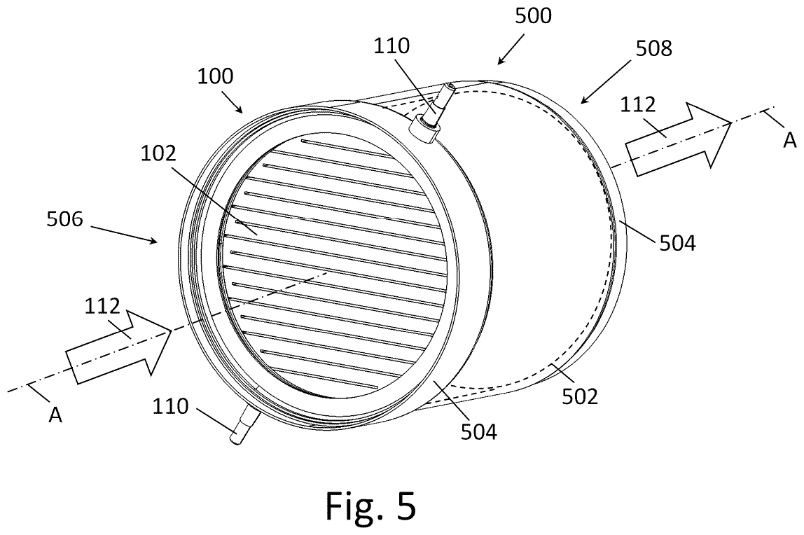

FIG. 5 shows a perspective representation of an exhaust gas treatment device 500 comprising an inlet 506 and an outlet 508. The exhaust gas treatment device 500 comprises a heating device 100 and a catalytic converter unit 502 (shown as a dashed line). The heating device 100 and the catalytic converter unit 502 are held in a housing 504, wherein the catalytic converter unit 502 is reliably fixed in the housing 504 by at least one bearing mat (not shown). The heating device 100 comprises two electrodes 110 that are electrically conductively connected to a heating element 102. The heating element 102 can be formed according to any one of the embodiments described herein. The electrodes 110 are arranged in an electrically insulating manner against the housing 504, wherein the electrodes 110 extend through the housing 504 and electrically conductively contact the heating element 102. A control device (not shown) can be connected to the electrodes 110 to form a potential difference between the electrodes 110. The catalytic converter unit 502 is arranged directly following in the axial direction of a flow axis A at the heating device 100.

A gas flow 112, in particular an exhaust gas flow, flowing into the housing 504 through the inlet 506 in the axial direction of the flow axis A is heated by the heating device 100 so that the catalytic converter unit 502 reaches its operating temperature as quickly as possible. The heating device 100 is arranged between the inlet 506 and the catalytic converter unit 502, in particular directly in the flow direction of the exhaust gas along the flow axis A in front of the catalytic converter unit 502.

To be able to represent complex surface structures by means of TPMS structures, the triply periodic minimal surfaces of the electrically conductive heating element 102 can be produced by a 3D printing method; TPMS structures are in particular mainly produced by means of 3D printing methods due to their complex structures.

The use of TPMS structures in heating elements 102 can provide potential in the fields of thermal heating behavior, heat transfer—surface—and weight with regard to regulatory emission standards, for example EU7.

### REFERENCE NUMERAL LIST

100 heating device
102 heating element
103 housing part
104 carrier device
106 carrier element
108 carrier element
110 electrode
112 gas flow
114 inlet side
116 outlet side
202 heating segment
204 gap
206 right margin
208 left margin
210 channel
302 gyroid cell
304 three-dimensional structure
306 Schwarz diamond cell
308 three-dimensional structure
310 wall thickness
402 electrical line
404 control device
406 first electrode
408 second electrode
410 part body
500 exhaust gas treatment device
502 catalytic converter unit
504 housing
506 inlet
508 outlet
A flow axis
B axis of symmetry

What is claimed is:

1. A heating device for heating a gas flow, comprising:
an electrically conductive heating element; and
a carrier device having at least one electrically insulating carrier element for the electrically conductive heating element, wherein the electrically conductive heating element is formed as a three-dimensional structure whose surface is at least sectionally formed from triply periodic minimal surfaces.

2. The heating device according to claim 1, wherein the heating device is configured to heat an exhaust gas flow of an internal combustion engine.

3. The heating device according to claim 1, wherein the electrically conductive heating element has a substantially circular basic geometry.

4. The heating device according to claim 1, wherein the three-dimensional structure of the electrically conductive heating element has a uniform thickness.

5. The heating device according to claim 1, wherein the three-dimensional structure of the electrically conductive heating element at least sectionally has a different thickness.

6. The heating device according to claim 1, wherein the three-dimensional structure of the electrically conductive heating element is formed from a temperature-resistant material.

7. The heating device according to claim 1, wherein the three-dimensional structure of the electrically conductive heating element has a plurality of gyroid cells and/or a plurality of Schwarz diamond cells.

8. The heating device according to claim 1, wherein the electrically conductive heating element can be flowed through by the gas flow.

9. The heating device according to claim 1, wherein the electrically conductive heating element has at least two heating segments that are sectionally separated from one another by a gap.

10. The heating device according to claim 9, wherein gap is open at one side.

11. The heating device according to claim 1, wherein the electrically conductive heating element comprises at least two part bodies that are arranged such that the at least two part bodies can be flowed through successively or in parallel by the gas flow.

12. The heating device according to claim 11, wherein the at least two part bodies of the electrically conductive heating element are electrically controllable separately from one another by means of a control device.

13. The heating device according to claim 11, wherein the at least two part bodies of the electrically conductive heating element are electrically connected by means of a series connection or a parallel connection.

14. The heating device according to claim 1, wherein the at least one carrier element at least sectionally covers a marginal region of the electrically conductive heating element.

15. The heating device according to claim 1, wherein the at least one carrier element has at least two openings through which the electrically conductive heating element can be electrically contacted.

16. The heating device according to claim 1, wherein the electrically conductive heating element is electrically connected to at least two electrodes,
wherein an electrical potential difference can be formed between the at least two electrodes by means of a control device.

17. The heating device according to claim 16, wherein the at least two electrodes are arranged in an insulating manner against the at least one carrier element.

18. An exhaust gas treatment device comprising an inlet and an outlet and at least one exhaust gas treatment unit for treating an exhaust gas flow,
wherein a heating device is arranged between the inlet and the exhaust gas treatment unit, the heating device comprising an electrically conductive heating element; and a carrier device having at least one electrically insulating carrier element for the electrically conductive heating element,
wherein the electrically conductive heating element is formed as a three-dimensional structure whose surface is at least sectionally formed from triply periodic minimal surfaces.

19. The exhaust gas treatment device according to claim 18, wherein the at least one exhaust gas treatment unit is a catalytic converter unit.

20. The exhaust gas treatment device according to claim 18, wherein the heating device is arranged directly in the flow direction of the exhaust gas in front of the exhaust gas treatment unit.

21. An exhaust gas system of an internal combustion engine comprising an exhaust gas treatment device comprising an inlet and an outlet and at least one exhaust gas treatment unit for treating an exhaust gas flow, wherein a heating device is arranged between the inlet and the exhaust gas treatment unit, the heating device comprising an electrically conductive heating element; and
a carrier device having at least one electrically insulating carrier element for the electrically conductive heating element,
wherein the electrically conductive heating element is formed as a three-dimensional structure whose surface is at least sectionally formed from triply periodic minimal surfaces.
